(19) United States
(12) Patent Application Publication
(10) Pub. No.: US 2017/0127266 A1
(43) Pub. Date: May 4, 2017

(54) METHOD FOR ACTIVATING A CONFIGURATION MODE OF A DEVICE

(71) Applicant: Robert Bosch GmbH, Stuttgart (DE)

(72) Inventors: Jan Zibuschka, Magstadt (DE); Paulius Duplys, Markgroeningen (DE)

(21) Appl. No.: 15/335,147

(22) Filed: Oct. 26, 2016

(30) Foreign Application Priority Data
Nov. 2, 2015 (DE) 102015221372.2

(51) Int. Cl. H04W 8/22; H04M 1/725

(52) U.S. Cl. CPC H04W 8/22; H04M 1/72519; H04W 88/02

(57) ABSTRACT

Method for activating a configuration mode in a device which has a communications unit and a sensor unit, a configuration mode of the device being activated when the device detects a measured value outside a predefined measuring range via the sensor unit, and a configuration of the device by a second device via the communications unit being allowed only in the configuration mode.

### CROSS REFERENCE

The present application claims the benefit under 35 U.S.C. §119 of German Patent Application No DE 102015221372.2 filed on Nov. 2, 2015, which is expressly incorporated herein by reference in its entirety.

### BACKGROUND INFORMATION

In view of the increasing availability of sensors, actuators and other devices in connection with what is known as the “Internet of Things”, the topic of authenticating these devices vis-à-vis a central infrastructure, e.g., vis-à-vis a smart home, plays an ever more important role. The configuration of the devices should be as user-friendly as possible on the one hand, and ensure high security on the other. A core question is the authorization and validation of the user as to whether this user may actually configure a device in the first place.

In the publication “F. Stajano, R. Anderson: The Resurrecting Duckling: Security Issues for Ad-hoc Wireless Networks, University of Cambridge Computer Laboratory, 1999”, methods for a secure initial configuration of devices for the integration into a network are described.

In German Application No. DE 10 2014 208965, a method is described, in which a first network subscriber, already connected to a network, authenticates a second network subscriber vis-à-vis a network through an authentication challenge. The authentication challenge is an input instruction of the first network subscriber to the second network subscriber, e.g., a movement sequence which the second network subscriber is to execute and which is subsequently verified by the first network subscriber. After successful execution of this authentication challenge by the second network subscriber, the first network subscriber authenticates the second network subscriber vis-à-vis the network.

### SUMMARY

The present method relates to a method, a device, and a computer program that is set up to execute one of the methods.

A first device, which has a communications unit and a sensor unit for detecting physical measured variables, forms the basis in this context. It is proposed that an activation of a configuration mode of the first device takes place by the detection of a measured value of the sensor unit of the first device outside the measuring range predefined for the measured value. Furthermore, a configuration of the first device via the communications unit by a second device is permitted only in the configuration mode. The predefined measuring range is preferably a value range of a measured variable, for which the device was designed to detect measured values in a continuous-running operation. The continuous-running operation in particular is meant to indicate the measuring range that is actually used for the device in the daily operation.

The advantage of the present invention is that a user already proves his authorization to configure the device vis-à-vis the first device in that he modifies the environment of the device to the effect that the device detects measured values outside the predefined measuring range and activates its configuration mode. Since the user requires physical access to the device to do so, and since the method for activating the configuration mode of the device must be known to the user in addition, this method offers high protection against an improper configuration of the device by an unauthorized user. In addition, the method provides a high degree of user friendliness since no complex authentication of the user vis-à-vis the device is required for activating the configuration mode, e.g., by inputting a pass phrase, by a gesture check, by a check of physical features, etc.

By the activation of the configuration mode of the first device, the first device allows the receiving of data via the communications unit by a second device in one preferred development. In a preferred exemplary embodiment, the receiving of data is able to be carried out via an open or encrypted radio network that is broadcast by the first device.

The network provided by the first device may be made available upon the activation of the configuration mode of the first device, or it is made available by the first device on a permanent basis. In a preferred variant, the second device transmits configuration parameters to the first device via the communications connection, such as in which room in a house the device is to be used, but at least a key, e.g., a cryptographic or symmetrical key. With the aid of the received key, the first device is able to authenticate itself vis-à-vis a network provided by a third device. In one preferred example, the third device is a smart-home base station, which manages a multitude of different sensors for controlling a home-automation system.

A deactivation of the configuration mode of the first device may take place as a result of the concluded reception of the configuration parameters by the second device, or by a predefined time, or by a command transmitted by the second device or by the detection of a measured value of the sensor unit of the first device detected within the predefined measuring range.

Another advantage of the present invention is that the first device need not have any special operating elements such as a keyboard, touch display, control buttons etc., in order to activate the configuration mode, so that this solution is very cost-advantageous. By omitting these operating elements, the product furthermore may have a less complex design and can be manufactured in a more advantageous manner.

In addition, due to the introduced activation of the configuration mode of a device via a sensor unit, there is no need for a central instance that checks a configuration authorization of a device in order to verify whether a user may perform a configuration of a device.

The validation of the authorization as to whether a user may configure a device is very secure in this method, since the user already indicates his authorization for carrying out this configuration by using the device for detecting measured values outside the measuring range predefined for him.

The safety and reliability of the described approach stem from, inter alia, the fact that a user wishing to configure the device has already explicitly obtained his authorization for carrying out this configuration by the method for activating the configuration mode of the device, inasmuch as the user induces a detection of measured values outside the measuring range predefined for the device.

It is likewise very advantageous for the security of the method if the first device allows a modification of the memory area required for the configuration only in an active configuration mode, so that an attacker is no longer able to make changes prior to the activation and after the deactivation of the configuration mode.

### BRIEF DESCRIPTION OF THE DRAWINGS

Below, the present invention is described in greater detail with reference to the figures and on the basis of exemplary embodiments.

FIG. 1 schematically illustrates an exemplary design of the devices that interact with one another.

FIG. 2 shows the exemplary sequence of a method for the switchover of a device into a configuration mode.

### DETAILED DESCRIPTION OF EXAMPLE EMBODIMENTS

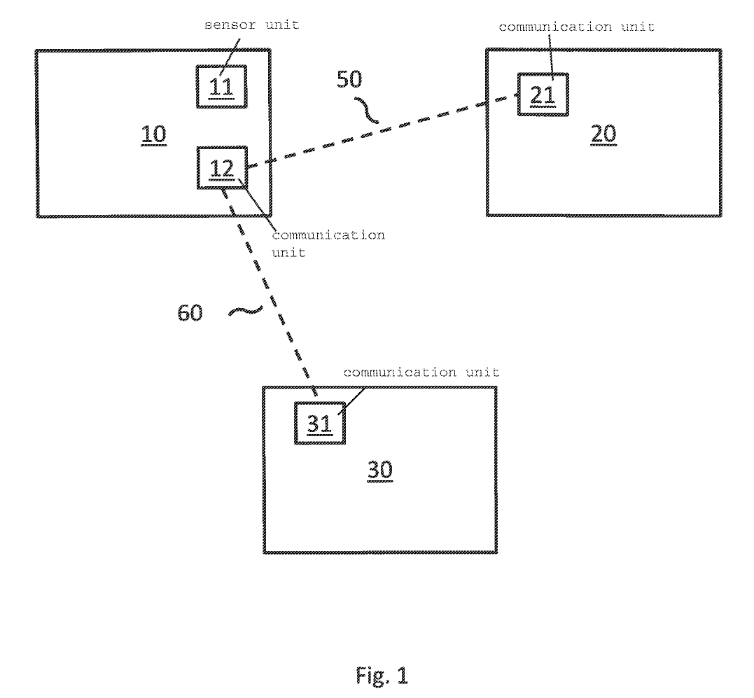

FIG. 1 shows three devices 10, 20 and 30, each having a communications unit (12, 21 and 31). In addition, device 10 has a sensor unit 11, via which a measured value is able to be detected. Devices 20 and 30 are able to communicate with device 10 via respective connections 50 and 60.

Device 10 includes a sensor unit 11 for acquiring measuring data, and a communications unit 12 for the communication with other devices. The communications unit is preferably a wireless unit. Different wireless technologies may be used. For instance, device 10 could communicate with device 20 via Bluetooth and device 10 with device 30 via W-LAN. In one advantageous development, a so-called “ad hoc” network is involved or a “Local Area Network”, to which second device 20 can connect itself via its communications unit 21.

In one preferred exemplary embodiment, device 10 is a sensor node (sensor-enabled device). A sensor node is a (terminal) device, which is equipped with one or multiple sensor(s). Conceivable are sensors for a multitude of physical variables, such as acceleration sensors, rate-of-rotation sensors, microphones (acoustic sensors), photo sensors (incl. cameras, brightness sensors), heat or thermo sensors (via resistance, optics, expansion, etc.), pressure sensors, gas sensors, moisture sensors, motion sensors, switches, etc. Combinations of different sensors are possible as well. Often, such a sensor node has no specified user interface (e.g., display, keyboard, operating elements), so that a simple and direct interaction between a user and the sensor node is frequently not possible.

Moreover, a predefined value range is defined for the acquisition of measured values by sensor unit 11 of device 10. If measured values outside this measuring range are detected via sensor unit 11, then a configuration mode of device 10 is activated. The predefined measuring range, for instance, is a value range which is actually utilized during the continuous-running operation of the device; in the case of a room thermometer, for example, which is to detect measured values between 5 and 40° C. during the continuous-running operation, it is this particular range. Temperatures higher than 40° C. and values lower than 5° C. thus lie outside the measuring range predefined for the room thermometer. In a preferred exemplary embodiment, this predefined measuring range is fixedly programmed in device 10. In an alternative specific embodiment, this predefined measuring range of device 10 may also be specified adaptively by measurements via sensor unit 11 in the current environment. For instance, the room thermometer could carry out measurements over three days and then specify the predefined measuring range by the measured minimum and maximum temperature.

Device 20 is preferably a device which includes a user interface, such as a display, a touch display, a keyboard, a microphone, a camera, as well as a communications unit 21. In one advantageous development of the present invention, a portable operating device is involved, such as a tablet-PC or a smartphone, for instance.

In the preferred example, third device 30 is a network access node (network access entity); in particular, it may be a smart-home base station, which is able to manage a multitude of terminals for the control of a home-automation system. For this purpose, device 30 preferably provides an encrypted wireless network for the communication. The connection to this network may be implemented using a multitude of already established methods, for instance through the use of a pre-shared key or a certificate-based authentication method, based on a public key infrastructure.

In one preferred exemplary embodiment, the individual devices are separate units. As an alternative, however, second device 20 and third device 30 could be logical instances of the same unit or the same device. For example, third device 30 could be equipped with operating units such as a display and keyboard, so that a configuration of first device 10 would be possible.

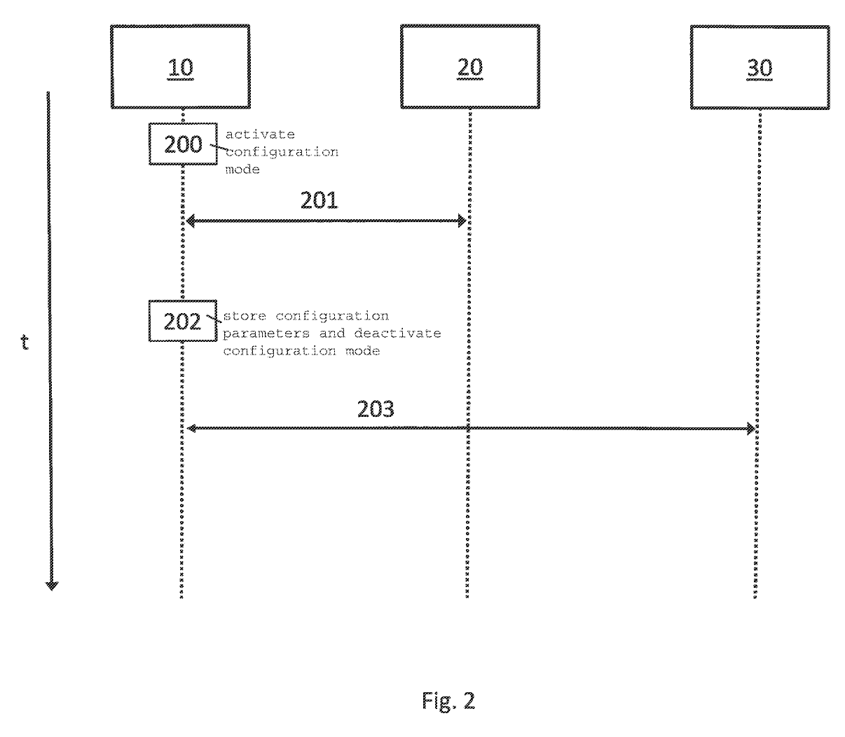

FIG. 2 once again shows devices 10, 20 and 30, which correspond to devices 10, 20 and 30 from FIG. 1, as well as an exemplary temporal sequence of the method for activating the configuration mode of device 10. Arrows indicate data transmissions between devices 10, 20 and 30, which are denoted according to FIG. 1 and the above explanations.

In a first step 200, a configuration mode of device 10 is activated as a result of the detection of a measured value outside a measuring range predefined for device 10, by the sensor unit. Because of the activation of the configuration mode, it is now possible to carry out a configuration of device 10 via its communications unit 12, for instance via a radio connection 50, with the aid of device 20.

In a preferred exemplary embodiment, device 10 activates an unencrypted or encrypted wireless network for this purpose, so that device 20 is able to establish a connection to device 10. In an alternative specific embodiment, device 10 makes an unencrypted or encrypted wireless network available on a permanent basis during the operation, but accepts a connection to other devices only when the configuration mode is activated for device 10. As an alternative, device 10 could allow a connection through another device as a matter of principle, but accepts the receiving of data only when the configuration mode of device 10 is activated.

In a step 201, device 20 establishes a connection to device 10 in the sense that device 20 is able to exchange data with device 10 in the first place. The manner in which such a connection may take place depends on the specifically considered transmission system and is standardized or specified accordingly. Device 10 receives configuration parameters through device 20, preferably including at least one cryptographic key, in particular a symmetrical key. As an alternative, the configuration parameters can also be access-control guidelines. The access-control guidelines specify which remote devices, users or services may access the sensor via the network, such as via the MAC address, IP address, passwords, etc. To do so, the sensor may have a function for storing the configuration parameters, which is specially protected, e.g., a physical unclonable function or a trusted platform module. Furthermore, device 10 allows a modification of data in a memory area for the configuration of device 10 only upon the activation of the configuration mode of device 10. For instance, a modification of the memory area for the configuration of device 10 could be controlled by a software function, which allows the modification of the memory area only in the configuration mode of device 10.

In a third step 202, in which the configuration of device 10 by device 20 is concluded after the configuration parameters have been received, device 10 stores the configuration parameters in a storage medium and deactivates the configuration mode.

In a step 203, device 10 establishes a connection to a device 30 and authenticates itself vis-à-vis a network of device 30 with the aid of the configuration data received from device 20, in particular by the symmetrical key. Device 30 checks the configuration data received from device 10. In case of a match of the configuration data, in particular a match of the symmetrical key, device 30 accepts the authentication in the network by device 10. If the configuration parameters, above all the symmetrical key, are not correct, the authentication of device 10 is rejected by device 30 and can be repeated, depending on the development of steps 200 through 205.

The described approach is of particular interest for a secure and simple integration of different devices in connection with the “Internet of Things”, for instance in the case of devices for the home and building automation, for telemedicine or the automotive industry.

What is claimed is:

1. A method for activating a configuration mode in a device, the device having a communications unit and a sensor unit, the method comprising:
activating the configuration mode of the device when the device detects a measured value outside a predefined measuring range via the sensor unit, a configuration of the device by a second device via the communications unit being allowed only in the configuration mode.

2. The method as recited in claim 1, wherein the device allows a receiving of data from the second device via the communications unit by the activation of the configuration mode.

3. The method as recited in claim 1, wherein the device receives configuration parameters from the second device via a communications connection including at least one key, and the device authenticates itself vis-à-vis a network with the aid of the configuration parameters.

4. The method as recited in claim 3, wherein the device deactivates the configuration mode again one of: i) following the reception of the configuration parameters by the second device, ii) after a predefined time following the activation of the configuration mode of the device, iii) by a command received from the second device, or iv) by a detection of a measured value within the predefined measuring range.

5. The method as recited in claim 1, wherein the device allows a modification of data in a memory area for the configuration of the device only in the configuration mode.

6. The method as recited in claim 1, wherein the second device is an input device, the input device being a smartphone.

7. The method as recited in claim 3, wherein the network is a wireless network including a radio network.

8. An non-transitory electronic storage medium on which is stored a computer program for activating a configuration mode in a device, the device having a communications unit and a sensor unit, the computer program, when executed by a processor, causing the processor to perform:
activating the configuration mode of the device when the device detects a measured value outside a predefined measuring range via the sensor unit, a configuration of the device by a second device via the communications unit being allowed only in the configuration mode.

9. A device having a non-transitory electronic storage medium, a communications unit and a sensor unit, the electronic storage medium storing a computer program for activating a configuration mode in the device, the computer program, when executed by a processor, causing the processor to perform:
activating the configuration mode of the device when the device detects a measured value outside a predefined measuring range via the sensor unit, a configuration of the device by a second device via the communications unit being allowed only in the configuration mode.
